(19) United States
(12) Patent Application Publication
(10) Pub. No.: US 2005/0079780 A1
(43) Pub. Date: Apr. 14, 2005

(54) Fiber wear layer for resilient flooring and other products

(76) Inventors: Richard E. Rowe, Dalton, MA (US); Mahendra Mehta, Pittsfield, MA (US); Mark A. Johnson, Chillicothe, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/684,913

(22) Filed: Oct. 14, 2003

(51) Int. Cl. B32B 27/12; B32B 27/04; B32B 5/02; B32B 29/02; B32B 3/26; D04H 1/08

(52) U.S. Cl. 442/33; 428/195.1; 442/43; 442/30; 442/45; 442/56; 442/58; 442/320; 442/326; 428/318.4; 428/304.4

(57) ABSTRACT

A laminar product comprising an overlay and a base layer, the overlay including a fibrous web impregnated with a saturating resin, the base layer being a resilient resin layer or a felt or matted layer.

### BACKGROUND OF THE INVENTION

The present invention is directed to a laminar product and, more particularly, to a laminar product having an overlay impregnated with a saturating resin laminated to a base layer. The laminar product of the invention is particularly useful as flooring, wallboard, and the like.

Wear resistant overlays have been used effectively in manufacturing decorative laminates. These overlays are well known in the art. They are typically formed from a cellulosic fiber web and, more particularly, a low basis weight alpha cellulose paper which incorporates an abrasion resistant filler or grit. When the paper and grit matrix is saturated with the resin, the resin wets the surface of the grit and the fiber and the overlay becomes transparent as a result of the similar indices of refraction of the materials. Examples of wear resistant overlays can be found in U.S. Pat. No. 3,798,111 to Lane; U.S. Pat. No. 4,713,138 to Ungar; U.S. Pat. No. 5,141,799 to Mheta; U.S. Pat. No. 5,268,204 to Hill et al. among others.

Floor, wall, and ceiling coverings are also well known. In many cases these coverings are manufactured from polyvinyl chloride resins. To impart wear resistance, the coverings are over coated with a clear liquid or semi-liquid wear-resistant resinous composition. Typical resins used in these wear resistant layers are vinyl resins, polyurethanes or acrylated polyurethane resins. While these resinous wear layers have been somewhat effective, new wear layers are desired having improved abrasion and scuff resistance and improved dimensional stability.

### SUMMARY OF THE INVENTION

The present invention provides a laminar product having a resin impregnated overlay laminated to a base layer. In accordance with one embodiment of the invention, the base layer is a resilient resin layer of the type used in such products as vinyl composition tile (VCT) or vinyl or linoleum flooring products including loose lay and tension flooring products. In accordance with another embodiment of the invention, the base layer is a felted or matted fibrous sheet. In still another embodiment of the invention, a floor covering is provided which comprises a resin impregnated overlay paper, a layer of a foamed polyvinyl chloride (PVC) resin, and a felt layer.

In accordance with one embodiment of the invention, in order to impart decorative characteristics to the laminate a print layer may be associated with either the felted or matted base layer or the foamed resin layer. Alternatively, in lieu of or in addition to incorporating a print layer into the laminate, decorative inclusions may be included in the resilient resin layer, the felted or matted base layer or the foam layer. In still another embodiment of the invention, the print layer may be incorporated on the back (inside) surface of the overlay.

### BRIEF DESCRIPTION OF THE DRAWINGS

FIG. 1 is a cross section of a laminar product in accordance with one embodiment of the invention.

FIG. 2 is a cross section of a floor covering in accordance with another embodiment of the invention.

FIG. 3 is a cross section of a laminar product in accordance with an embodiment of the invention in which the base layer is a felted or matted base layer.

FIG. 4 shows a typical process for manufacturing the laminate of the present invention.

### DETAILED DESCRIPTION OF THE INVENTION

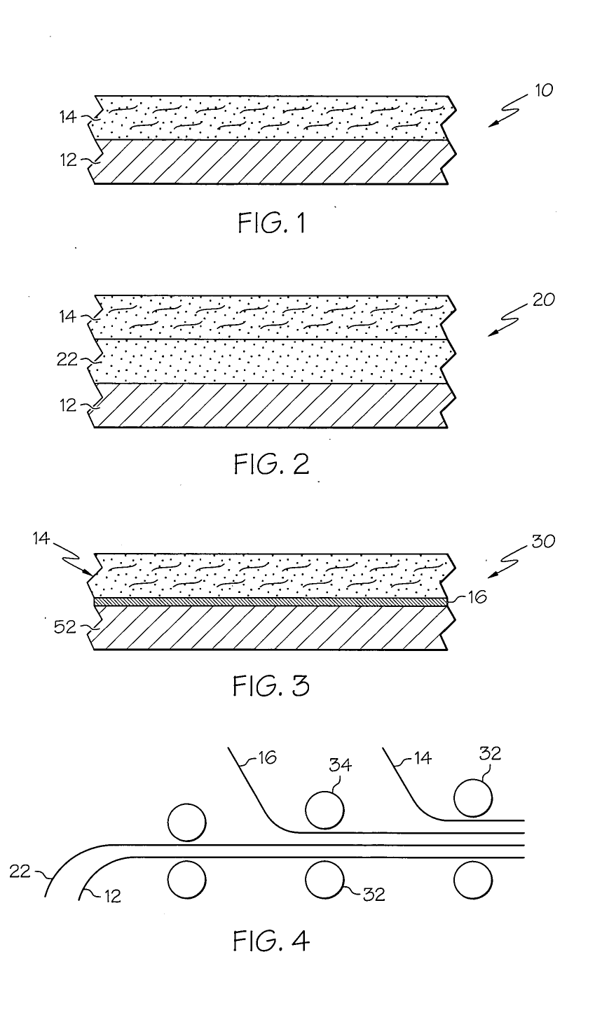

In accordance with the invention, the wear characteristics of various laminar products are improved by incorporating a resin-saturated fiber overlay onto the surface of the product. FIG. 1 illustrates a laminar product in accordance with one embodiment of the invention. This laminar product 10 is made up of a base layer 12 and a overlay 14. In accordance with one embodiment of the invention, the base layer 12 is a resilient resin layer of the type used in such products as vinyl flooring, vinyl composition tile (VCT), printed cushioned roto vinyl sheet, roto vinyl tile, stencil inlayed sheet, calendared inlayed sheet, homogenous vinyl sheet, linoleum, heterogenous vinyl sheet, luxury vinyl tile. In accordance with the invention the resin-saturated fiber overlay is bonded to any of the foregoing substrate or base layers to provide a product having improved wear and/or scuff resistance and/or improved dimensional stability.

FIG. 2 illustrates an embodiment of the invention in which the laminar product 20 is a product such as flooring and includes a resilient resin base layer 12, a foamed resin layer 22 and a wear-resistant overlay layer 14. In the illustration, a print layer 16 is incorporated in the product 20 between the foamed layer 22 and the overlay layer 14 but the print layer is optional. The print layer 16 can be applied to the overlay or the print layer can be applied to the foam layer.

In one embodiment of the invention improved vinyl composite tile is provided. The structure shown in FIG. 1 is the structure of a vinyl composite tile when the base layer 12 is a composite of a resin, such as a vinyl resin, and a filler such as ground limestone. In accordance with the invention, the wear and scuff resistant characteristics of the tile are improved by bonding or adhering the saturating resin-impregnated paper overlay to the exposed surface of the base layer 12, which in this case is the limestone-resin composite.

FIG. 3 illustrates a further embodiment of the invention in which the laminar product 30 includes a felt or matted base layer 52 and a saturating resin impregnated overlay 14. In accordance with the illustrated embodiment, a print layer 16 is formed on the surface of the felt or matt layer 52. Alternatively, as discussed elsewhere herein, decorative inclusions can be incorporated directly in the base layer 52 in lieu of a print layer.

The overlay 14 can be formed from any natural or synthetic fiber. In particular any of the fibers conventionally used in natural and synthetic paper products may be used. In one embodiment the overlay 14 is a composite of a low basis weight cellulose fiber paper of the type conventionally used in forming overlays in the decorative laminating field, and a saturating resin which impregnates the overlay. One of the most common fibers used in overlays is alpha cellulose or mixtures thereof with other cellulose fibers, e.g., a highly bleached fibrous cellulosic pulp and/or alpha pulp beaten to a Canadian Standard Freeness of about 500 ml. The cellulose fibers used in the overlay are preferably bleached Kraft pulp, although any fiber used in conventional overlay sheets may be employed. The pulp may consist of hardwoods or softwoods or a mixture of hardwoods and softwoods. Higher alpha cellulose such as cotton may be added to enhance characteristics such as post-formability. Overlay sheets useful in the present invention are known in the art. Examples of overlay sheets in addition to those cited above can be found in Canadian Patent 990,632 and U.S. Pat. Nos. 3,135,643; 3,445,327; 3,525,664; 3,798,117; and 3,975,572.

The overlay paper typically has a basis weight of about 15 to 30 pounds per 3,000 square feet without pigment filler. With pigment (discussed later), the basis weight is about 20 to 50 pounds per 3,000 square feet.

The fibers forming the overlay and the saturating resin are selected such that their respective indices of refraction closely match such that the overlay transparentizes when it is dried and cured. Examples of saturating resins that may be impregnated into the overlay fibers include vinyl chloride resins, acrylics (Armorez 2955 available from MeadWestvaco Specialty Chemicals) polyurethanes, and acrylated polyurethanes. Preferably a resin is selected which enhances the scratch and abrasion resistance of the laminate. Two polyurethanes that are particularly useful in the invention are HD 2209 and HD 2107 which are polyester polyurethanes that are available from Hauthane as waterbome compositions. Conventional polyurethane resins are reaction products of one or more polyols and one or more polyisocyanates. Examples of polyurethanes are well known in the art. Acrylated polyurethanes can be prepared by the methods described in U.S. Pat. No. 4,100,318. Other examples of potentially useful resins are diallyl phthalate polyester (DAP) resin described in JP7256818 (1995); thermoplastic polyurethane (TPU) film by melt molding described in U.S. Pat. No. 5,821,180 (1998) and U.S. Pat. No. 6,592,692 (2003); crosslinkable electronic beam (EB) and UV-curable epoxy resins, polyester-polyurethane resins described in U.S. Pat. No. 6,333,076 (2001); UV-crosslinkable brushable PVC—acrylate hybrid resins described in DE Patent 3543266 (1986) and polyurethane (meth)acryalte resins described in U.S. Pat. No. 5,843,576 (1998); alkylated melamine resin—polyurethane blend described in U.S. Pat. No. 5,643,677 (1997); moisture curable polyurethane-ureas described in U.S. Pat. No. 5,140,088 (1992); epoxy/silicate hybrid organic/organic wearlayer described in U.S. Pat. No. 5,023,140 (1991); melamine/polyol/cellulose acetate wearlayer described in U.S. Pat. No. 4,983,466 (1991); and organosilicon wear layer polymer described in CA Patent 2164062 (1997).

Normally, the resin will be impregnated into the laminate in the form of a solution or dispersion such as an aqueous solution or a solvent-base solution. It may also be feasible, in some cases, to impregnate the resin into the overlay in the form of a melt. In one potential embodiment, the wear-resistant resin can be provided in the form of a film which is juxtaposed with the overlay and heated to melt the film such that it impregnates the overlay. For example, plasticized PVC film can be press molded into overlay fibers using procedures outlined in Japanese Patent 53094576. Alternately, paper can be coated with liquid PVC polymer prior to press molding according to Gagne U.S. Pat. No. 4,041,197(1977) or Werner, A. C., Vinyl Plastisol and Organosol Coatings for Paper. Tappi J. 50(1):79A-84A. 1967 3. Another method for melt molding polyurethane into an overlay is described in U.S. Pat. No. 5,821,180. The resin is typically incorporated in the overlay in an amount of about 50% to 400% based upon dry weight of the paper.

After impregnating the resin into the overlay, the overlay is assembled with the laminate to provide the structures illustrated in FIGS. 1-3. In accordance with one embodiment of the invention, the resin-impregnated overlay is assembled with the base layer or the foam layer while the resin-impregnated overlay is wet and the overlay is cured in place on the surface of the laminate. In this embodiment, as the overlay cures, the overlay bonds to the underlying base layer 12 or foam layer 22. This is particularly useful when the impregnating resin is a polyurethane.

In another embodiment of the invention, the resin impregnated overlay is cured (e.g., dried or crosslinked) prior to assembly with the base layer and thereafter the cured overlay is bonded to the surface of the base layer 12 or the foam layer 22 using a suitable adhesive. Examples of adhesives that may be useful in bonding the overlay to form the laminate include cyanoacrylates, hot melt adhesives and water borne polyurethane adhesives. Those skilled in the art will appreciate that substantially any adhesive that is waterproof and compatible with the properties of the resin impregnated overlay the base sheet can be used in the invention.

In various products, to make the laminate aesthetically appealing, the laminate includes a print layer including any desirable decorative pattern or image. The print (decorative) layer may consist of a layer of ink or solid inclusions, metal flakes, polyester glitter, colored wax, colored PVC particles or core-shell particles, nacreous pigment, resin particles, natural materials such as leaves, stems, flowers petals, grasses, paint chips, confetti paper, colored quartz chips or other minerals, colored glass particles, twine, string, bark, wood flour, or cork. In one embodiment an image simulating wood appearance may be used. Alternatively, decorative inclusions may be incorporated directly in the base layer 12 alone or with the print layer. Decorative inclusions include decorative elements known in the art such as pearlescent pigments, metal particles and shavings, and any of the decorative additives used in making decorative laminates or flooring materials. In VCT, a print layer is not normally used. The decorative elements are incorporated in the composite forming the tile.

In a particular embodiment of the invention, the print layer may be formed on the back surface of the overlay 14 such that the print layer is incorporated into the laminate 10 with the overlay 14 when it is assembled with the base layer 12 as described later herein.

The thickness of the base layer 12 will be comparable to thicknesses routinely encountered in the vinyl flooring and decorative laminating arts. For example, the base layer 12 that is found in many vinyl flooring products is usually about 80 to 150 mils thick. In VCT the composite layer is usually about 100 to 125 mils thick. One of the advantages of certain embodiments of the invention is that it permits the thickness of the wear layer to be reduced. Conventionally wear layers in vinyl flooring products may range from approximately 5 to 16 mils thick. Because the wear layer of the present invention is reinforced with fiber such as cellulose, the layer provides improved structural integrity. The layer is less likely to chip or tear upon cutting. Consequently, in certain embodiments of the invention, it is possible to use wear layers that may be as thin as about 1 to 3 mils thick. However, in other embodiments of the invention, the overlay may range from about 2 to 5 mils think.

In accordance with the invention, resin saturated overlays are combined with any of a variety of the base layers used in floor and wall products. The preferred and most widely used resin for the foamed layer 22 is PVC. The PVC can be a homopolymer of vinyl chloride, or copolymers, terpolymers, or the like. Examples of vinyl chloride homopolymers, copolymers, and terpolymers that have been used in the manufacture of foamed layers are provided in U.S. Pat. No. 4,264,643 which is incorporated herein. While vinyl chloride resins are preferred for use in the foamed layer 22, it will be apparent to those skilled in the art that the layer 22 can be formed from any resin which can be foamed with a blowing agent. Other resins which may be useful include polyethylene, polypropylene, methacrylates, rubbers, polyurethanes, and the like. Other examples of resins that may used in forming the layer 22 are provided in aforementioned patent.

The layer 22 can be formed by applying a plastisol to the surface of the felt layer 42. Conventionally, these plastisol compositions contain 20 to about 150 parts plasticizer per 100 parts resin. Useful plasticizers are well known in the art. This foamable composition is typically a dispersion of a resin in a plasticizer, i.e., a plastisol. The preferred and most widely used plastisols are polyvinyl chloride (PVC). In accordance with the invention an overlay that has been impregnated with a wear resistant resin is bonded to the outer surface of the foamed PVC to provide a wear layer on the top surface of the laminate. The compositions additionally contain an effective amount of a blowing agent. The amount of the blowing agent is adjusted depending upon the density of the foam that is desired. Examples of useful plastisols, plasticizers, and blowing agents are provided in U.S. Pat. No. 4,264,643 and U.S. Application 20020127372.

Vinyl composite tile layers are made up of ground limestone and/or ground ceramics and resins such as polyvinyl chloride (PVC), or PVC replacements or substitutes such as described in U.S. Pat. No. 5,910,358 and US 20030166754 (polyolefins), ionomeric resins as described in U.S. Pat. No. 5,728,476, polyacrylate/chlorinated polyethylene as described in U.S. Pat. No. 4,083,821, Dupont's Surlyn ionomeric resin as described in WO 95/11333, acrylate plastisols as described in EP 0342562, ethylene vinyl acetate copolymer as described in EP0528194, or melt processable non-platstisols as described in U.S. Pat. No. 6,511,926. Other resilient flooring types also may include these resins with different fillers, plasticizers, antioxidants, antistatic agents and colorants. Other resilient flooring types include those based on cork, rubber or linoleum which is a natural material of epoxidized linseed oil and wood flour, cork filler and colorants. Any of these flooring types may be covered with a saturated paper wear layer as described here, even if they are not normally produced with a wear layer during manufacturing. This also includes saturated paper wear layers on non-resilient flooring such as hardwood, plywood, particle board and engineered wood, such as those described in CN 1381342, U.S. Pat. Nos. 4,210,692, 3,551,272, GB 1115942, U.S. Pat. Nos. 4,541,880, 3,666,593, 5,116,446, 5,143,418, 6,497,937, KR2001004829, U.S. Pat. No. 5,925,211, GB 1197229, U.S. Pat. Nos. 4,083,743, and 1,597,539. Wear layers added during manufacturing are known to reduce the repeated labor and material costs of flooring maintenance with temporary waxes, acrylics or other polymers over the life of the floor. These wear layers also add greater ease of cleanability, antisoiling and improved stain resistance. Silylated acrylic polymers may be added to the saturating polymer mixture to improve cleanability similar to those described in JP 2003237008, JP 2003039622 and JP 2003225985.

In accordance with one embodiment of the invention, the overlay sheet contains an abrasion resistant mineral pigment. While those skilled in the art will appreciate many abrasion-resistant pigments can be used in the present invention the preferred pigments have a Mohs hardness of at least about 3, preferably at least about 5. In one embodiment of the invention a pigment filler as described in U.S. Pat. No. RE 30,233 may be used. This pigment has a Mohs hardness greater than 6.0 and an average particle size of about 30 to 100 microns. Representative examples of mineral pigments that may be used include silica, alumina, titanium oxide, tin oxide, zirconium oxide, and the like. In a particular embodiment of the invention, the wear resistant pigment is a rounded grain quartz (Wedron 710 available from Fairmount Minerals). An abrasion resistant filler may be incorporated in the overlay in an amount up to about 40 grams per square meter and preferably about 5 to 30 grams per square meter.

The abrasion resistant filler may be incorporated into the overlay using a number of techniques. One technique involves mixing the pigment with a paper furnish from which the overlay is formed on the paper making machine. Another technique involves adding an aqueous slurry of the pigment to the surface of the wet paper web through a secondary head box of a papermaking machine. The slurry of mineral particles cascades over and through the cellulose fibers and causes the particles to become embedded in the overlay. Another method that can be used to deposit the mineral particles involve use of a slot orifice coater and is described in U.S. Pat. No. 5,820,937. Still another method for preparing the abrasion-resistant particle-containing overlay is described in U.S. Pat. No. 6,287,681. In a further embodiment of the invention, the overlay 12 is actually made up of three sublayers, namely, a first layer of cellulose, a layer of abrasion resistant particles, and a second layer of cellulose fibers. The layers of cellulose fibers sandwich and entrap the intervening layer of mineral pigment. This overlay can be manufactured as described in U.S. Pat. No. 6,551,455. This overlay is particularly amenable to backside printing because the mineral pigment is shielded from the print layer.

With reference more specifically to the structure shown in FIG. 3, examples of this felted or matted base layer are described in U.S. Pat. No. 4,225,383 to McReynolds which is incorporated herein by reference. In accordance with a particular embodiment of the invention, the felted or matted base layer is formed from cellulose fiber. The felt layer can be manufactured using conventional equipment for felt manufacture. Conventionally, a water dispersible fiber is admixed with water to provide an aqueous dispersion containing from about 5 to 15 percent water-dispersible fiber using a hydropulper. A finely-divided filler may be admixed with the fiber in the hydro-pulper. The mixture is blended with an organic polymer in the form of a latex which is flocculated to form a fibrous agglomerate that is formed into a web on a papermaking machine. Base layers have been formed from any water insoluble, natural or synthetic water-dispersible fiber including wood pulp, glass fiber, cotton and linen rag, and synthetic pulp. Particularly useful fibers are cellulosic and lignocellulosic fibers commonly known as wood pulp of various kinds from hardwood and softwood such as stone ground, mechanical, chemimechanical, chemical, and semichemical pulp. More specifically bleached or unbleached sulfite and sulfate pulps may be used.

The fillers that may be used in the base layer include any of those conventionally used in the art including calcium carbonate, titanium dioxide, and the like. The binder used in forming the felted layer may be natural or synthetic and may be a homopolymer or copolymer. Preferably the polymer is a latex. Representative polymers are acrylics, polyvinyl acetates, natural rubber, synthetic rubbers, etc.

A representative example of manufacture of the laminate is illustrated schematically in FIG. 4 for the flooring of FIG. 2. This process can be used with appropriate modification manufacturing other laminar products. Typically a felt 12 and a foamed plastisol sheet 22 will be bonded together and assembled with a print sheet 16. The print sheet can be printed using a rotogravure print roll 34. The pressures and temperatures required to accomplish each of these operations are well known in the art. The overlay 14 is fed to the laminate and bonded in place using a heated roll 36. The overlay can be bonded to the felted base sheet or the foamed layer using various different techniques. In one embodiment of the invention, the resin-impregnated overlay is assembled with the base sheet 12 or the foamed sheet 22 while the overlay is wet and the assembly is heated to drive the water or solvent from the resin-impregnated overlay whereupon the overlay becomes bonded to the underlying substrate. In another embodiment of the invention, the resin-impregnated overlay is cured. Curing can consist of drying the overlay or inducing cross-linking reactions which harden the resin within the overlay. In this instance, the cured overlay is assembled with the underlying substrate by means of any of the adhesives previously discussed. Generally, the amount of heat and pressure required to bond the overlay to the underlying substrate is not extreme. Pressure is deliverable from a conventional pressure roller, for example, about 2 to 40 pli, and temperatures of about 100 to 200° C. are sufficient to effect bonding to the substrates.

One of the advantages of using saturating resin-impregnated overlays in these laminar products such as flooring products is the embossability of the overlay. With reference to FIG. 4, the heated roll 36 that is used to bond the laminate together or a dedicated embossing roll can have a smooth finish or a textured or ornamental finish. Upon contacting the overlay with the heated roll 36 under appropriate temperature and pressure conditions, the pattern on the surface of the roll 36 will be imparted into the overlay which upon curing retains the desired texture or ornamental appearance.

The examples set forth below represent embodiments of the abrasion resistant laminate of the present invention and methods for making this laminate and are not intended to be limiting. Varying amounts, types and or thicknesses of the components of the laminate may be used in the invention.

### EXAMPLES

### Experimental

Lab Preparation of Overlay Papers Bonded to Resin:Samples (6″×6″) of wear resistant overlay paper having a basis weight of 33 or 45 grams per square meter (gsm) at 18% or 30% 70 μm average diameter white electrofused alumina were placed in a vacuum flask with 1 liter of Hauthane HD 2209 or HD 2107 polyester-aliphatic polyurethane dispersion at 35% solids or a 50:50 blend of HD2209 and MeadWestvaco Specialty Chemicals' acrylic. House vacuum was applied and released sequentially about 3 times to fully degass the solution and infiltrate the paper matrix.

The wet saturated sheet of overlay paper was removed from the flask and laid felt side down on one of the following the base layers: (1) Black Glosstech 5 Vinyl Film Base bonded to a melamine resin saturated and b-stage cured white barrier film (the barrier film provides a white rigid background for observing the wear); (2) Armstrong Excelon VCT, or (3) Homogeneous Vinyl. Excess resin and air bubbles were removed by rolling over the sample with a smooth round #0 Meyer rod. The sample was allowed to air dry and self cure for 1 hour at room temperature. The dry resin pick up by the sample was in the range of 100 to 150% of the weight of the paper. The sample firmly and uniformly bonded to the vinyl surface giving a dry transparent film of low gloss.

Scuff resistance was measured by BYK Gardner Scuff Tester Model AG-8100 using Norton UPC code 66261126339 P100-J grit sandpaper. Gloss at 60° was measured after every 10 scuffs. The results are shown in Table 1.

Taber abrasion resistance was measured by the grit feeder weight loss method (ASTM F-510). The results are shown in Table 2.

The sample was cut into a 4″×4″ square and tested for abrasion resistance by the initial point/end point (IP/EP) method described in International Standard EN 438-2. The abrasion resistance is reported in Table. Transparency of the saturated and bonded overlay was measured by optical density over black vinyl with a X-Rite Model 518LP Spectrodensitometer. Values close to 2.0 or higher were considered to be excellent in clarity. Values below 1.8 were considered fair to poor.

TABLE 1
Scuff Test

| | | | | Scuffs | |
|---|---|---|---|---|---|
| | Gloss | | Scuffs/Point | to 50% | % |
| Sample | Initial | Final | Gloss Loss | Gloss | Improve |
| Scuffs | 0 | 50 | | | |
| Armstrong Excelon VCT | | | | | |
| Uncoated Control | 6.2 | 3.1 | 16 | 50 | |
| Saturated 33 gsm WROL | 5.8 | 4.1 | 29 | 85 | 71% |
| 50:50 Acrylic/ | | | | | |
| Polyurethane | | | | | |
| Benchmark | 22.7 | 6.2 | 3 | 34 | −31% |
| WearMax (TM) | | | | | |
| Coating no paper | | | | | |
| Homogeneous Vinyl | | | | | |
| Uncoated Control | 5.2 | 3.2 | 25 | 65 | |
| Saturated 33 gsm WROL | 6.4 | 4.8 | 31 | 100 | 54% |
| Polyurethane only | | | | | |

TABLE 2
Taber Abrasion Resistance by the Grit Feeder
Method (ASTM F-510)

| | Weight Loss | % |
|---|---|---|
| | 1,000 cycles | Improve |
| Armstrong Excelon VCT | | |
| Uncoated Control | 0.0853 | |
| Saturated 33 gsm WROL | 0.0511 | 40% |
| 50:50 Acrylic/Polyurethane | | |
| Benchmark WearMax (TM) Coating no paper | 0.0370 | 57% |
| Homogeneous Vinyl | | |
| Uncoated Control | | |
| Saturated 33 gsm WROL | 0.0173 | 58% |
| Polyurethane only | | |

TABLE 3
Abrasion Resistance by the IP/EP Method (EN 438-2)

| | | Grams per | Grams per | | Transparency |
|---|---|---|---|---|---|
| | | m\hat{ }2 | m\hat{ }2 | | by |
| Black Glosstech 5 Vinyl | | Polyurethane | Fused | Grit Size | Optical |
| Film Base | Cycles | Resin | Alumina | um | Density |
| Conrol (no coating or | 325 | 0 | 0 | — | 2.55 |
| overlay) | | | | | |
| Hauthane 2107 saturated | 1460 | 60 | 13.5 | 70 | 1.82 |
| 45 gsm WROL | | | | | |
| Hauthane 2209 saturated | 1350 | 73 | 13.5 | 70 | 2.02 |
| 45 gsm WROL | | | | | |
| Hauthane 2209 saturated | 950 | 97 | 0 | — | 1.58 |
| 42 gsm overlay | | | | | |
| Hauthane 2209 saturated | 650 | 53 | 0 | — | 1.86 |
| 23 gsm overlay | | | | | |
| Benchmark WearMax | 1150 | 120 | 13.5 | 50 | 2.12 |
| (TM) Coating no paper | | | | | |

Results showed a 50-70% improvement in scuff resistance and a 40-60% improvement in abrasion resistance with the Hauthane 2209 saturated WROL wear layer by the weight loss method. Wearmax Ceramic Armor after market coating alone only showed improvement abrasion resistance (60%). The blend of acrylic and polyurethane worked better for scuff resistance (gloss retention) than polyurethane alone because the acrylic polymer contributes to maintaining gloss.

Abrasion resistance measured by the initial point/end point method showed that fused alumina was critical to obtaining high abrasion levels. Both the WROL paper and benchmark polyurethane coating containing grit (WearMax) could deliver high abrasion, but saturated paper without grit (42 and 23 gsm) could not.

Stain testing and water immersion testing (4 hours) were also done. The only sample that showed any staining (betadine, catsup and mustard) was control uncoated white homogeneous vinyl (mustard). Samples with the acrylic resin in the saturant showed some cloudiness after 4 hours of immersion in cold water. Samples with the polyurethane alone showed no effect of water immersion. All samples remained bonded during the water immersion test.

Engineered wood flooring samples, both UV-cured polyurethane finished (6 layers) and unfinished 600 um veneer on HDF, belonging to the Par-Ky brand of Decospan were obtained from Europe. Samples were laminated with melamine resin saturated transparent overlay prepreg felt side down at using 45 gsm paper at 30% fused alumina, 320 degrees F., 500 psi, for 2.5 minutes and cooled for 8 minutes before opening the press. Similar scuff and abrasion tests were performed as described above. Results are shown in Table 4.

TABLE 4
Abrasion Resistance by the IP/EP Method

| | | | Scuff | |
|---|---|---|---|---|
| | Abrasion | | Resistance | |
| | Resistance | | Cycles to | |
| Par-Ky Base Wood Veneer | Cycles | % | 50% | % |
| Flooring on HDF | (IP + EP)/2 | Improvement | Gloss Loss | Improvement |
| Control (no coating or overlay) | 700 | — | 8 | — |
| Melamine Resin saturated 45 gsm | 4200 | 600% | 55 | 688% |
| WROL | | | | |
| Par-Ky with commercial 6-layer | 1100 | 157% | 36 | 450% |
| UV-cured Polyurethane | | | | |

Results from the table above show that lamination of a melamine saturated wear resistant paper overlay to wood veneer flooring gives at least a six-fold improvement in abrasion and scuff resistance in a single layer while the 6-layer polyurethane gives a two to four fold improvement. Similar results are expected with saturated wear resistant overlay prepared by alternate grit addition technologies (liquid overlay, etc, EP 1216759, U.S. Pat. Nos. 6,231,670, 6,432,201, 6,471,776, 6,558,754, US 20030010285, etc.)

Dimensional Stability.

Difficulties in forming a clear vinyl wear layer on a foamed vinyl base without wrinkles, curling, cupping, doming and buckles have been an issue with vinyl products such as flooring. Loose lay type flooring, because it is not reinforced by attachment to the floor, has even greater tendency to form these defects when heavy furniture is rolled over the surface. A further advantage of certain embodiments of the present invention is that the saturated paper wear layer adds dimensional stability that resists the tendency toward these problems. Evidence of this effect comes from tensile measurements of the wear layer polymer with and without paper.

In order to evaluate the dimensional stability obtained with saturated paper overlays versus conventional wear-resistant coatings alone, tensile testing was done comparing free films of HD 2209 and a vacuum saturated overlay of HD 2209. Comparison of the dimensional strength of a polyurethane and polyurethane saturated WROL paper was done by casting the saturated overlay or polymer alone on a silicone based release paper and peeling off after curing. Free film strength was measured in an Instron tensile tester. The results are shown in Table 5 below.

TABLE 5

| | Sheet | Wgt of | Caliper of | | Tensile | Load/Width | | | |
|---|---|---|---|---|---|---|---|---|---|
| | WGT As Is- | Sheet | Raw | | Energy | at Max. | | Load at | |
| | 25 sq in | after | Paper | Caliper | Absorption | Load | Max % | Max Load | Slope |
| Sample ID | area | Vac Sat. | (Mils) | (mils) | (ft.lb/ft) | (lbf/in) | Strain | (lbf) | (lbf/in) |
| HD 2209 | 1.5627 | | | 2.3800 | 117.7960 | 4.8930 | 329.8090 | 2.8890 | 6.0130 |
| Film Only | | | | | 96.1590 | 4.2620 | 319.6340 | 2.5170 | 3.8960 |
| | | | | | 110.4060 | 4.8080 | 313.0370 | 2.8390 | 5.9780 |
| Mean | | | | | 108.1200 | 4.654 | 320.827 | 2.748 | 5.296 |
| 33 Gsm vac | 0.5178 | 1.3560 | | 3.6250 | 5.0010 | 15.6500 | 4.8490 | 9.2420 | 70.4870 |
| sat with HD | | | | | 4.7350 | 13.6260 | 5.3960 | 8.0470 | 52.6390 |
| 2209 | | | | | 5.4100 | 16.0750 | 5.2210 | 9.4930 | 66.0010 |
| Mean | | | | | 5.049 | 15.117 | 5.155 | 8.928 | 63.043 |
| 45 Gsm vac | 0.7409 | 1.6235 | | 4.3500 | 6.4180 | 21.2610 | 4.8270 | 12.5560 | 80.1520 |
| sat with | | | | | 6.4860 | 20.5950 | 4.8970 | 12.1620 | 82.4940 |
| HD 2209 | | | | | 6.1720 | 19.3580 | 5.1280 | 11.4320 | 68.2670 |
| Mean | | | | | 6.3590 | 20.4050 | 4.9510 | 12.0500 | 76.9710 |

| | | | | | | |
|---|---|---|---|---|---|---|
| 33 gsm Raw Paper | 3.4012 | 0.8320 | 7.6060 | 1.4930 | 4.4920 | 129.6860 |
| | | 0.6920 | 6.5490 | 1.4660 | 3.8680 | 98.2110 |
| | | 0.7340 | 6.8700 | 1.4560 | 4.0570 | 115.7060 |
| Mean | | 0.7520 | 7.0080 | 1.4710 | 4.1390 | 114.5340 |
| 45 gsm Raw Paper | 4.3225 | 1.3560 | 9.7700 | 1.9250 | 5.7690 | 135.5760 |
| | | 1.4700 | 10.1960 | 1.9970 | 6.0210 | 138.6600 |
| | | 1.3440 | 9.9210 | 1.8770 | 5.8590 | 145.7170 |
| Mean | | 1.3900 | 9.9620 | 1.9330 | 5.8830 | 139.9840 |

The results show that the saturated overlay is 4 to 5 times stronger (load/width at max) than the polymer film alone and 2 to 3 times stronger than the paper alone.

Having described the invention in detail and by reference to specific embodiments thereof, it will be apparent that numerous variations and modifications are possible without departing from the spirit and scope of the invention as defined by the following claims.

1. A laminar product comprising an overlay and a base layer, the overlay including a fibrous web impregnated with a saturating resin, the base layer being a resilient resin layer or a felt or matted layer or wood layer.

2. The laminar product of claim 1 wherein the base layer is a resilient layer containing a vinyl resin.

3. The laminar product of claim 2 wherein the overlay is a cellulose web.

4. The laminar product of claim 3 wherein the saturating resin is a polyurethane, an acrylic, or a melamine formaldehyde resin.

5. The laminar product of claim 3 wherein the base layer includes a foamed polymeric layer and a felt or mat layer, wherein the foamed polymeric layer is interposed between the felt layer and the overlay.

6. The laminar product of claim 1 wherein the product further includes a print layer.

7. The laminar product of claim 6 wherein the print layer is interposed between the overlay and the balance of the laminate.

8. The laminar product of claim 7 wherein print layer is applied to the surface of the overlay adjacent the base layer.

9. The laminar product of claim 5 wherein the foamed layer is formed from a polyvinyl chloride plastisol.

10. The laminar product of claim 9 wherein the laminate further includes a print layer.

11. The laminar product of claim 10 wherein the print layer is interposed between the overlay and the remainder of the laminate.

12. The laminar product of claim 11 wherein print layer is applied to the surface of the overlay adjacent the base layer.

13. The laminar product of claim 4 wherein the saturating resin is a water soluble polyurethane.

14. The laminar product of claim 3 wherein the overlay includes a wear-resistant pigment.

15. The laminar product of claim 14 wherein the pigment is rounded quartz.

16. The laminar product of claim 14 wherein the pigment is fused alumina.

16. The laminar product of claim 1 wherein the fibers include alpha cellulose.

17. The laminar product of claim 1 wherein the overlay has a basis weight of about 17 to 30 lbs per 3,000 square feet.

18. The laminar product of claim 3 wherein the overlay inclusive of the wear-resistant pigment filler has a basis weight of about 20 to 47 lbs per 3,000 square feet.

19. The laminar product of claim 1 wherein the laminate is suitable for use as flooring.

20. An abrasion resistant laminate comprising a felt layer and an overlay overlying the felt layer, the overlay including a fiber web impregnated with a saturating resin.

21. The laminar product of claim 20 wherein the felt layer is formed from cellulosic fibers.

22. A laminar flooring product comprising a felt layer, a foamed layer of a vinyl resin, and an overlay, the overlay being a cellulose fiber web impregnated with a saturating resin.

23. The laminar product of claim 1 wherein the base layer is a composite of limestone and a vinyl resin.

24. A method for forming a wear layer on a vinyl base sheet which comprises:
impregnating a cellulose web with a wear-resistant resin,
drying or curing the resin, and bonding the impregnated web to the vinyl base sheet.
